(19) United States
(12) Patent Application Publication
(10) Pub. No.: US 2016/0363941 A1
(43) Pub. Date: Dec. 15, 2016

(54) HOT WATER RECIRCULATION VALVE

(71) Applicant: Jerry R. Lizaso, Santa Ana, CA (US)

(72) Inventor: Jerry R. Lizaso, Santa Ana, CA (US)

(21) Appl. No.: 14/737,428

(22) Filed: Jun. 11, 2015

(51) Int. Cl. G05D 23/13

(52) U.S. Cl. CPC G05D 23/1313

(57) ABSTRACT

A valve for use in a water circulation system having a source of unheated water and a source of heated water, said valve comprising: a housing defining a heated water input, an unheated water input and an output; a valve stem supported within said housing defining a primary flow passage, an output passage in fluid communication with said primary flow passage and a bypass flow passage; a handle constructed to facilitate movement of said valve stem between an off position, an on position and a bypass position, wherein said on position has said valve stem positioned within said housing such that said primary flow passage provides water flow from said heated water input and said unheated water input to said output passage and said bypass passage is blocked and wherein said off position has said primary flow passage and said bypass passage blocked and wherein said bypass position has said bypass flow passage couples said heated water input to said unheated water input and said primary flow passage is blocked.

### FIELD OF THE INVENTION

This invention relates generally to hot water systems and particularly to hot water systems which are directed towards water conservation.

### BACKGROUND OF THE INVENTION

In most typical water supply systems used in residential and commercial facilities, a hot water heater is provided which supplies heated water to the various apparatus and utilization facilities within the system. A plurality of pipes are configured to circulate both hot and cold water to the various faucets, sinks and shower facilities within the residential or commercial structure.

While cold water supply systems are relatively straight forward and provide a direct supply of cold water under sufficient operating pressure to cause water flow throughout the system, hot water supply and circulation presents additional problems not encountered in cold water supply and circulation. Because water heaters are often distant from the various water using facilities throughout the environment, they necessarily travel through an extensive and lengthy network of pipes. The time spent in the hot water supply pipes during periods of nonuse allows the water within the pipes to cool. As a result, hot water supply is often prohibitively cool at the various hot water apparatus within the system. The most prevalent solution for the quantity of cooled water which resides within hot water supply system following periods of nonuse is to simply run the hot water faucet or the like in an open condition until the cooled water has been replaced by heated water. While this solution is to some extent effective, the cooled water which is allowed to flow from the system presents a substantial quantity of wasted water. For the most part, the water is simply allowed to enter the drain system and is, in essence, lost.

In attempting to solve the problem presented by heated water cooling within the supply pipes during periods of nonuse and to avoid the water loss occasioned by simply running the hot water to exhaust the cooled residue, practitioners in the art have developed a variety of hot water recirculation systems. Perhaps the most prevalent hot water recirculation system is provided in which a normal hot water and cold water circulation system is provided with an additional hot water circulation return line that is plumed into the system during construction and installation. The additional hot water circulating line typically runs from the hot water utilizing facility to return to the hot water heater. A pump is provided within the recirculating system to cause hot water to constantly circulate to the utilization facility and returning to the hot water heater. Such hot water recirculation systems provide an effective solution to the basic problem of heat loss within hot water supply pipes. However, the use of such hot water circulation systems proves to be expensive and must be planned for and plumed into the water supply system during construction of the residential or commercial property. As a result, such recirculation systems are not capable of being added to existing residential or commercial locations and as such are not “retro-fit” systems.

Confronted with the growing concerns of water shortages and the need for water conservation throughout many areas of habitation, practitioners in the art have provided certain retrofittable hot water recirculation systems suitable for a limited number of facilities. U.S. Pat. No. 8,534,310 issued to Ziehm sets forth a HOT WATER CIRCULATION SYSTEM in which a bypass valve is coupled between the hot and cold water supply pipes at a sink or other system facility. The bypass valve functions to allow water to flow from the hot water supply pipe to the cold water supply pipe. Circulation of the hot water within the cold water supply is facilitated by a convection flow within the water circulation system. While the system set forth in U.S. Pat. No. 8,534,310 is to some extend an improvement over the basic water circulation systems in that it may be retro-fitted within certain existing facilities, the apparatus is substantially limited to facilities such as sinks or the like in which access to the hot water and cold water supply pipes is available. As a practical matter, the system set forth in U.S. Pat. No. 8,534,310 is not suitable for application to installed water circulation systems such as a shower or other facility due to the location of the hot water and cold water supply pipes within finished walls of the shower facility. Also, in many environments, the shower facility is located a substantial distance from the water heater allowing heated water in the pipes to cool.

Other examples of additional prior art systems directed toward hot water circulation and recirculation include a variety of developments. For example, U.S. Pat. No. 5,606,987 issued to Weber sets forth an ENERGY CONSERVING HOT WATER FAUCET DRIBBLE BYPASS METHOD AND APPARATUS in which cold water subrogates hot water supplied to a leaky hot water faucet. An individual kitchen or bathroom faucet set incorporates an anti-dribble control feature to substitute cold water trickle for wasteful hot water trickle through the leaky hot water faucet.

U.S. Pat. No. 5,331,996 issued to Ziehm sets forth a DUAL MODE HOT WATER CIRCULATION APPARATUS which supplies instantaneous hot water to faucets remote from the heater in residential or small commercial building water systems. The apparatus comprises a cold water heat exchanger, a high sensitivity check valve, and an aspirator incorporated into a single unit. The heat exchanger is a chamber installed in the cold water supply line containing a cooling tube exposed to the water. The check valve has a neutral buoyancy poppet and closes against an angular seat. The aspirator has a reduced cross section nozzle inside a tapered chamber connected to the water supply pipe with a low pressure tap in the chamber bore.

U.S. Pat. No. 8,851,021 issued to Kim et al sets forth a METHOD FOR CONTROLLING HOT WATER TEMPERATURE THROUGH OPERATION OF A CIRCULATION PUMP that includes determining whether a user uses the hot water, determining whether one of the circulation pump operating modes is selected and circulating the hot water in an outflow pipe to an inflow pipe by operating the circulation pump.

U.S. Pat. No. 7,036,520 issued to Pearson, Jr. sets forth a HOT WATER HEATER RECIRCULATION SYSTEM AND METHOD that includes a source of hot water, a fixture, a fluid circuit, a fluid pump and an electrical circuit sensor. The fixture is remote from the source of hot water and is configured to dispense hot water. The fluid circuit extends from the source to the fixture for delivery hot water to the fixture. The fluid circuit returns to the source for recirculating hot water in the fluid circuit back to the heating source for reheating. A fluid pump is figured for recirculating hot water through the fluid circuit.

U.S. Pat. No. 5,829,467 issued to Spicher sets forth a RESIDENTIAL HOT WATER CIRCULATION SYSTEM AND ASSOCIATED METHOD that recirculates cooled hot water into the base of hot water heater through its drain valve utilizing an electrically driven pump. The recirculating system incorporates portable self-contained signally units which use photosensitive motion sensitive or infrared sensitive detectors to sense changes within their field of sensitivity to signal the pump controller to activate the pump.

U.S. Pat. No. 4,316,367 issued to Yaeger et al sets forth a HEAT RECOVERY AND HOT WATER CIRCULATION SYSTEM for use with refrigerator system and a hot water reservoir.

U.S. Pat. No. 4,977,885 issued to Herweyer et al sets forth a HOT WATER HEATING SYSTEM WITH SELECTIVE BYPASS utilized in supplying water heated to a desired temperature range to a facility having a demand for heated water which varies widely between a normal flow rate and a peak flow rate. The system includes a water heater having an output capable of supplying water heated to the desired temperature at the normal flow rate and a storage tank for storing additional water heated to the desired temperature. When the flow rate increases above the normal flow rate, unheated water is supplied to the tank and heater and heated water is withdrawn from the tank.

U.S. Pat. No. 4,609,007 issued to Uhl sets forth a MIXING VALVE FOR CONNECTION TO HOT AND COLD WATER SUPPLY LINES FOR FEEDING A VARIABLY PROPORTIONED MIXTURE OF HOT AND COLD WATER TO A SHOWER HEAD OR THE LIKE that includes a valve body having a planar discharge surface defining spaced hot and cold water inlet orifices with an outlet orifices generally centered on an axis between the hot and cold inlet orifices. A cap defining an inverted cup shape is sealed against the planar member water flow selection is accomplished by rotation against the planar member bring various coupling passages into alignment with the orifices.

While the foregoing prior art structures have generally improved the art and in some instances enjoyed limited commercial success, there remains nonetheless a continuing and unresolved need for hot water recirculation system which avoids wasting runoff water and may be retro-fitted into existing shower facilities without the need for replumbing the shower wall.

### SUMMARY OF THE INVENTION

Accordingly, it is a general object of the present invention to provide an improved hot water recirculation system which makes hot water available at a hot water discharge following periods of nonuse. It is a more particular object of the present invention to provide an improved hot water recirculating system that may be retro-fitted to existing shower facilities. It is a still more particular object of the present invention to provide an improved hot water recirculation system that is particularly suited for original installation at the time of construction or conversion of an existing shower facility to include hot water recirculation. It is a still more particular object of the present invention to provide an improved hot water recirculation system that does not necessitate a constant hot water recirculation.

In accordance with the present invention, there is provided a valve for use in a water circulation system having a source of unheated water and a source of heated water, said valve comprising: a housing defining a heated water input, an unheated water input and an output; a valve stem supported within said housing defining a primary flow passage, an output passage in fluid communication with said primary flow passage and a bypass flow passage; a handle constructed to facilitate movement of said valve stem between an off position, an on position and a bypass position, wherein said on position has said valve stem positioned within said housing such that said primary flow passage provides water flow from said heated water input and said unheated water input to said output passage and said bypass passage is blocked and wherein said off position has said primary flow passage and said bypass passage blocked and wherein said bypass position has said bypass flow passage couples said heated water input to said unheated water input and said primary flow passage is blocked.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth an operational block diagram of a hot water recirculation system utilizing a hot water recirculation valve constructed in accordance with the present invention;

FIG. 2 sets forth a perspective view of a hot water recirculation valve constructed in accordance with the present invention;

FIGS. 3A through 3C set forth front views of the present invention hot water recirculation valve in its on, off and recirculate positions;

FIG. 4A sets forth a side elevation view of a hot water recirculation valve constructed in accordance with the present invention having its handle on the on position;

FIG. 4B sets forth a section view of the present invention hot water recirculation valve taken along section lines 4B-4B in FIG. 4A;

FIG. 4C sets forth a section view of the present invention hot water circulation valve taken along section lines 4C-4C;

FIG. 5A sets forth a side elevation view of the present invention hot water recirculation valve having its handle in the off position;

FIG. 5B sets forth a section view of the present invention hot water recirculation valve taken along section lines 5B-5B in FIG. 5A;

FIG. 5C sets forth a section view of the present invention hot water recirculation valve taken along section lines 5C-5C in FIG. 5A;

FIG. 6A sets forth a side elevation view of the present invention hot water recirculation valve having its handle in the recirculation position;

FIG. 6B sets forth a section view of the present invention hot water recirculation valve taken along section lines 6B-6B in FIG. 6A;

FIG. 6C sets forth a section view of the present invention hot water recirculation valve taken along section lines 6C-6C in FIG. 6A;

FIG. 7 sets forth a perspective assembly view of a hot water recirculation valve constructed in accordance with the present invention;

FIG. 7A sets forth an enlarged perspective view of the valve stem used in a hot water recirculation valve constructed in accordance with the present invention;

FIGS. 8A through 8D set forth water flow illustrations of the operation of the present invention hot water recirculation valve in the on, off and bypass handle positions;

FIG. 9 sets forth a perspective assembly view of an alternate embodiment of the present invention hot water recirculation valve;

FIG. 9A sets forth an enlarged perspective view of the valve stem used in a hot water recirculation valve constructed in accordance with the present invention;

FIGS. 10A through 10D set forth water flow diagrams for the operation of the alternate embodiment shown in FIG. 9 of the hot water recirculation valve in the open, closed and bypass positions of the valve handle; and

FIG. 11 sets forth a section view the present invention hot water recirculation valve taken along section lines 11-11 in FIG. 4A.

### DESCRIPTION OF THE PREFERRED EMBODIMENTS OF THE INVENTION

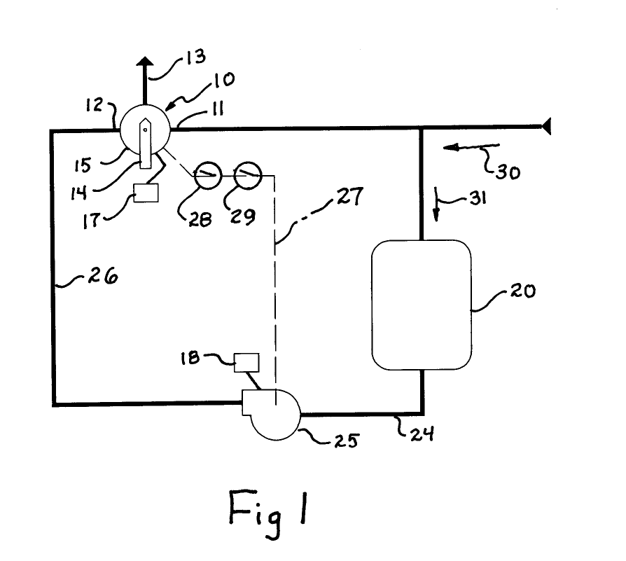

FIG. 1 sets forth a functional block diagram of a hot water recirculation system utilizing the present invention hot water recirculation valve constructed in accordance with the present invention. A hot water recirculation valve generally referenced by numeral 10 is constructed in accordance with the present invention and is coupled to a cold water input 11 and a hot water input 12. Valve 10 is further coupled to an output 13. Valve 10 further includes a housing 15 and a handle 14 the structures of which are set forth below in greater detail. The system shown in FIG. 1 further includes a heater 20 constructed in accordance with conventional fabrication techniques. A water supply input 21 is coupled to a heater input 22 and a cold water pipe 23. Heater 20 is further coupled to a pump 25 by a heater output pipe 24. The output of pump 25 is coupled to valve hot water input 12 by a pipe 26. As is better seen in FIG. 11, housing 15 supports a thermocouple switch 28 and a magnetic switch 29. An electrical activation line 27 is coupled between switches 28 and 29 supported within valve 10 (not shown) and pump 25. Activation line 27 and switches 28 and 29 are operative to activate pump 25. In addition, it will be noted that activation line 27 may utilize a direct wire connection or a wireless communication link. In the latter case, a sending unit 17 at valve 10 responds to switches 28 and 29 to communicate with a receiving unit 18 coupled to pump 25.

During normal operation and assuming valve 10 is initially set at its off position characterized by an absence of water flow through output 13, water flow initially through supply input 21 in the direction indicated by arrow 30 and into pipe 23 filling pipe 23. The water flow into heater 20 fills heater 20 and results in filling pipes 24 and 26. With valve 10 in the off position, pump 25 is deactivated. As a result, once pipes 22, 23, 24 and 26 together with heater 20 are filled with water, no further water flow is present within the system. The pressure within the system corresponds to the supply pressure at supply input 21.

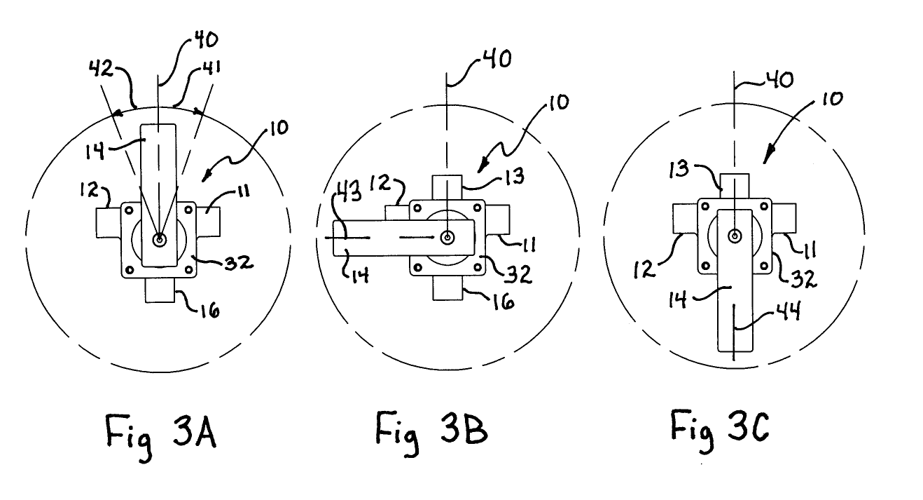

During normal use of the system of FIG. 1, valve 10 is configured in its normal operate position by moving handle 14 to the position shown in FIG. 3A. With handle 14 moved to the on position of FIG. 3A, water flows from supply 21 through pipe 23 and through cold water input 11 into and through valve 10. Similarly, hot water flows through pipe 24 from heater 20 and through pipe 26 to hot water input 12. A quantity of hot water then flows through valve 10. The proportion of hot water and cold water flow is determined by small angular movements of handle 14 as seen in FIG. 3A. During this normal use, heater water is drawn from heater 20 for use within the host shower facility and is replaced by cold water from supply 21 through pipe 22 in the direction indicated by arrow 31. Once the user has finished operation of the host facility, handle 14 may be returned to the off position shown in FIG. 3B.

At this point, the operation of the system shown in FIG. 1 is entirely in accordance with conventional practices. It will be noted that once valve 10 is placed in the off condition, flow of heated water through pipes 24 and 26 ceases as does the flow of cold water through pipe 23. As the heated water remains static within pipe 26, the pipe and the heated water therein gradually cools. Following a significant period of nonuse, the previously heated water within pipe 26 cools to the surrounding temperature of its environment. In the absence of the present invention improvement, the substantial quantity of cooled water within pipes 24 and 26 must be run through valve 10 by opening valve 10 to the flow condition. The cooled water is then caused to flow from pipes 24 and 26 and outwardly through the valve to the system drain. This flow is typically continued until the cooled water within pipes 24 and 26 has been replaced by freshly heated water. It will be apparent to those skilled in the art that this runoff of cool water prior to use represents a substantial waste of water.

In accordance with the present invention and to avoid the waste of cooled water runoff, the present invention provides an additional function for valve 10. This additional function referred to herein as a “bypass” function is achieved by moving handle 14 to the recirculation position shown in FIG. 3C below. In accordance with an important aspect of the present invention and as is set forth below, placing handle 14 in the recirculation or bypass position couples a water flow passage between hot water input 12 and cold water input 11. Concurrently, and in further accordance with the present invention, a signal is provided by valve 10 which is coupled by line 27, either wirelessly or by direct wiring, to pump 25. The activation of pump 25 produces a pressure increase within pipe 26 and raises the pressure at hot water input 12 above the pressure at cold water input 11. In addition, as pump 25 continues to operate it draws water from heater 20 via pipe 24 and reduces the water pressure within pipes 24 and 22. As a result, a circulation flow is set up within the system by which heated water flows through pipes 24 and 26 to hot water input 12. By means described below in greater detail, this water flow passes through a water passage formed within valve 10 to flow water outwardly through cold water input 11. The continued operation of pump 25 causes water flow from input 11 through pipe 23 to the junction of supply input pipe 21 and heater supply pipe 22. Because the water system pressure maintained within supply input 21 is greater than the water pressure within pipe 22, the flow of water through pipe 23 continues into pipe 22 and thereafter enters water heater 20. This constitutes the novel bypass operation of the present invention valve and system by which the cooled water within pipes 24 and 26 is replace by freshly heated water drawn from heater 20. This operation continues as water is circulated from heater 20 through pump 24 and through the bypass passage (shown below) within valve 10 and thereafter returns to heater 20 via cold water pipe 23 and heater supply 22. Once the cooled water within pipe 26 has been replaced with heated water, handle 14 may be moved to the off position shown in FIG. 3B. With handle 14 in the off position, the activation of pump 25 is terminated. Thereafter, the user is able to move handle 14 to the on position shown in FIG. 3A and with small angular movements adjust the proportion of heater water and cold water flowing outwardly through output 13.

While valve 10 may be moved by the user between the off position and bypass position as needed, the present invention system may be configured in an automatic recirculating operation using the combination of thermocouple switch 28, magnetic switch 29, the bypas position of valve 10 and pump 25. Thermocouple switch 28 is a normally closed switch that opens when hot water is sensed and closes when cooler water is sensed at valve 10 (seen in FIG. 11). Similarly, magnetic switch 29 (also seen in FIG. 11) is a Hall Effect switch, or equivalent, and is normally open. Switch 29 is closed by proximity of magnet 63 (seen in FIG. 11) when valve 10 is in the bypass position. Because switches 28 and 29 are connected in series, both must be closed to activate pump 25. Accordingly, with valve 10 in the bypass position, magnetic switch 29 is closed and thermocouple switch 28 controls the activation of pump 25. When the water at valve 10 cools, thermocouple switch 28 closes and pump 25 is activated providing the heated water recirculation described above. Once valve 10 is again heated, thermocouple switch 28 opens and pump 25 is inactive. Thus, each time the “hot” water at valve 10 cools, thermocouple switch 28 again closes and pump 25 is run until hot water at valve 10 is restored./

It will be apparent to those skilled in the art that the establishment of recirculation within the system that allows replacement of the cooled water within the hot water pipes with freshly heater water while avoiding any loss of water is extremely advantageous for purposes of water conservation. In essence, the present invention system utilizing valve 10 constructed in accordance with the present invention is able to establish a recirculation of water through the water heater and valve 10 by which all circulating water is returned to heater 20 and no water is lost to the system. In further accordance with an important advantage of the present invention and as is set forth below in greater detail, valve 10 provides a bypass water flow path through valve 10 which does not require any alteration of the host plumbing within the shower or other facility in which valve 10 is placed. For the most part, conversion of an existing system to the energy and water conserving present invention system simply requires removing the existing shower or other facility valve and replacing it with the present invention valve. No additional plumbing beyond that required to install pump 25 is required. In a typical installation, it will be anticipated that pump 25 is installed near water heater 20 at a convenient location, once again, avoiding the need for substantial system modification.

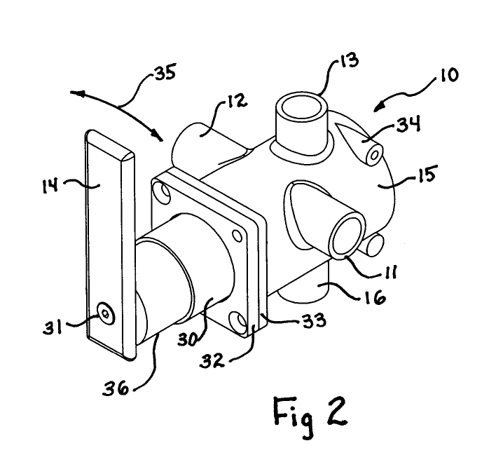

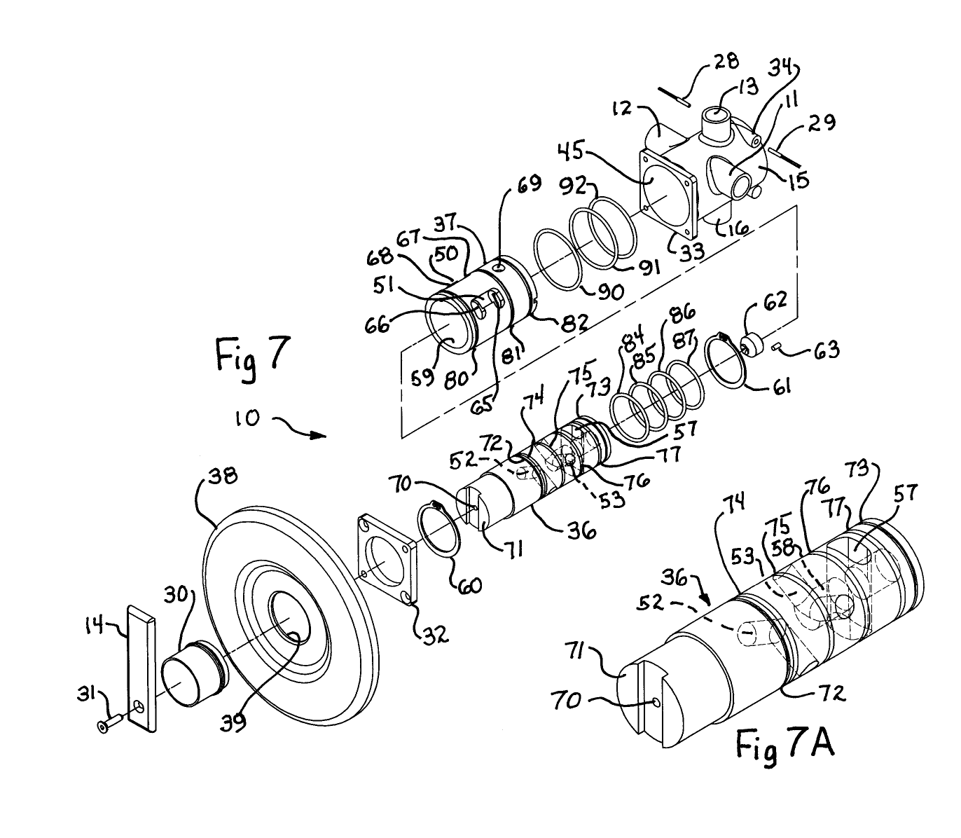

FIG. 2 sets forth a perspective view of hot water recirculation valve 10. As described above, valve 10 include a housing 15 which supports a cold water input 11 and a hot water input 12. As is also described above, housing 15 supports an output 13. In accordance with the intended use of valve 10 within a shower facility or the like, housing 15 further supports a downwardly extending output coupling 16. Housing 15 further supports a flange 33. Valve 10 further includes a generally cylindrical lock nut 30 supported by a flange 32. Handle 14 is secured to the valve stem of valve 10 in the manner set forth below in FIG. 7 utilizing a threaded screw 31. Flanges 32 and 33 are joined by conventional fasteners such as threaded screws (not shown). The internal mechanism within valve 10 is set forth below in greater detail. However, suffice it to note here that valve 10 is configured in accordance with a typical conventional shower facility valve or the like in order that cold water input 11, hot water input 12, output 13 and output 16 are in substantial alignment for simple installation within the shower wall once the conventional shower valve is removed. It will be apparent to those skilled in the art that cold water input 11, hot water input 12, output 13 and output 16 utilize conventional coupling attachment apparatus such as conventional threads or the like which are omitted from FIG. 2 to avoid unduly cluttering the drawing figure. Such coupling mechanisms are entirely within conventional fabrication techniques. As is described above, handle 14 is rotationally moveable in the manner indicated by arrows 35 to configure valve 10 in the alternate configurations required for operation. As is also described above, and as is set forth below in FIGS. 3A, 3B and 3C these rotational positions include the on position shown in FIG. 2, the off position shown in FIG. 2 and FIG. 3A, the off position shown in FIG. 3B and the bypass position shown in FIG. 3C. Examination of FIG. 2 also sets forth an important aspect of the present invention by which the bypass function utilized in the above-described hot water recirculation is carried forward by flowing water directly from hot water input 12 to cold water input 11 without resort to additional plumbing lines or supplemental plumbing paths. As a result, recirculating water during the bypass function is caused to flow through valve 10 and not around valve 10. This greatly simplifies the installation of valve 10 within an existing shower facility. Valve 10 may of course be plumbed into a shower or similar facility during original constructing without departing from the spirit and scope of the present invention. However, it will be understood that the capability of the present invention hot water recirculation valve to be “retro-fitted” into an existing shower or facility by simple removal of the valve and replacing it with the present invention valve. The avoidance of alternation of the plumbing within an existing shower wall or similar facility is a clear advantage of present invention system.

FIGS. 3A, 3B and 3C set forth simplified front views of valve 10 showing the rotation of handle 14 to the on, off and bypass valve positions respectively. Examinations of FIGS. 3A, 3B and 3C illustrates the simple manner in which valve 10 is configured in the on, off or bypass operational configurations. The user simply rotates handle 14 to enable valve 10 to perform the desired operational function.

More specifically, valve 10 includes a supporting flange 32 and a rotational handle 14. Valve 10 further includes a cold water input 11 and a hot water input 12. Valve 10 also includes outputs 13 and 16.

FIG. 3A shows valve 10 with handle 14 rotated to the on position characterized by position 40. With handle 14 in on position 40, the user is able to adjust the relative proportions of cold water and hot water flowing through valve 10 to outputs 13 and 16 by moving handle 14 through small angular increments. For purposes of illustration, movement of handle 14 in the direction indicated by arrow 41 increases flow from cold water input 11 and reduces flow from hot water input 12. Conversely, movement of handle 40 in the direction indicated by arrow 42 increases the flow of hot water from input 12 and reduces the flow of cold water from input 11. In this manner the user is able to balance the mixture of hot and cold water to achieve the desired temperature.

FIG. 3B sets forth valve 10 having handle 14 rotated to the off position. As will be understood, configuring valve 10 in the off position shown in FIG. 3B terminates all water flow through valve 10.

More specifically, valve 10 includes a supporting flange 32 and a rotational handle 14. Valve 10 further includes a cold water input 11 and a hot water input 12. Valve 10 also includes input 13 and 16.

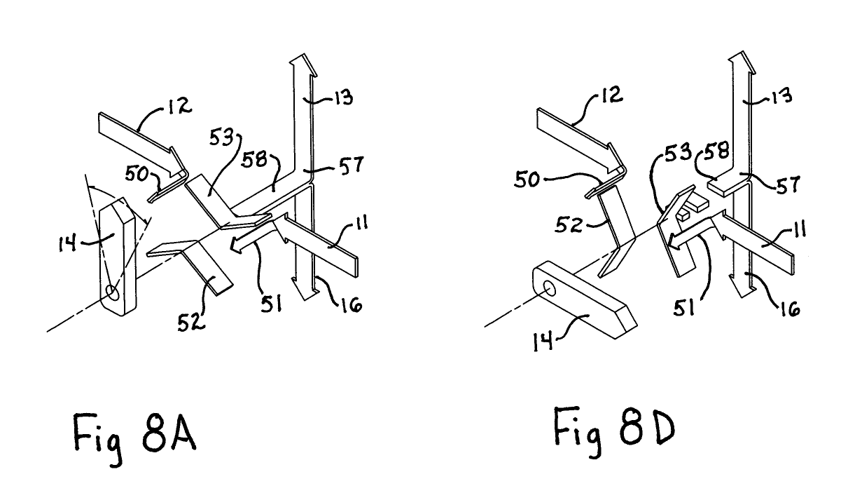

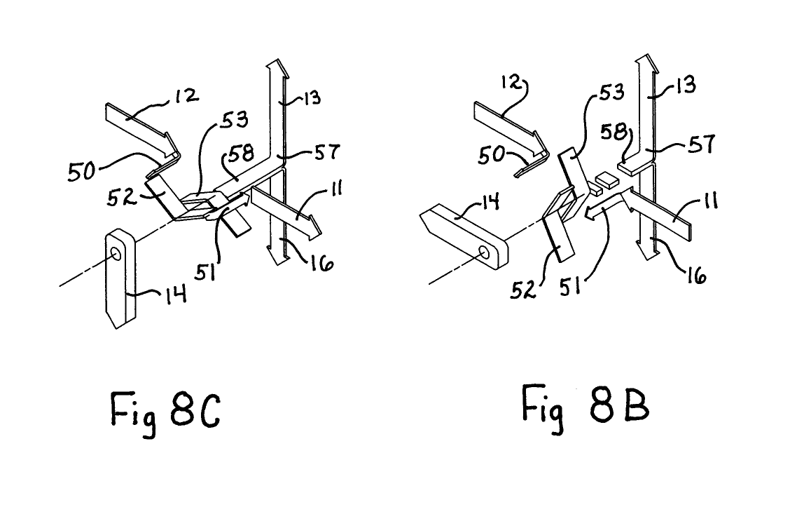

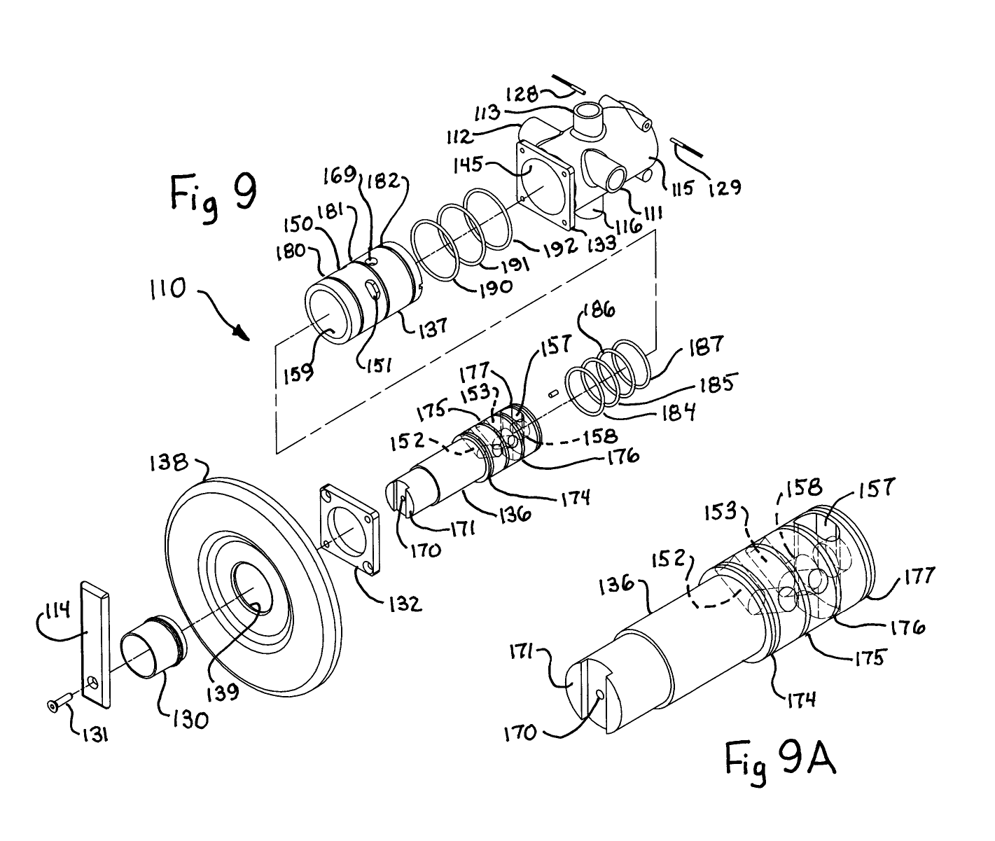

For purposes of illustration, the off position for handle 14 is shown as position 43. It will be apparent that while the on position shown in FIG. 3A corresponds generally to a “twelve o'clock” position, off position 43 corresponds to a “nine o'clock” position. As is set for the below in FIG. 8, the structure within valve 10 also provides a second off position which may be utilized if desired. This off position results from the structure of valve 10 and corresponds generally to the “three o'clock” position (not shown).

FIG. 3C sets forth a front view of valve 10 in which handle 14 has been rotated to the bypass configuration. It will be recalled that the operation of the present invention system which results when valve 10 is placed in the bypass configuration provides the recirculation of hot water within the system.

More specifically, valve 10 includes a supporting flange 32 and a rotational handle 14. Valve 10 also includes a cold water input 11 and a hot water input 12. Valve 10 also includes inputs 13 and 16.

In accordance with the above-described operation of valve 10 and as is set forth below in greater detail, the configuration of valve 10 in the bypass configuration shown in FIG. 3C allows water flow through valve 10 from hot water input 12 outwardly through cold water input 11. Thus, in accordance with an important aspect of the present invention, the recirculation or bypass water flow path of the present invention system flows directly through valve 10. As a result, no additional bypass plumbing path need be provided.

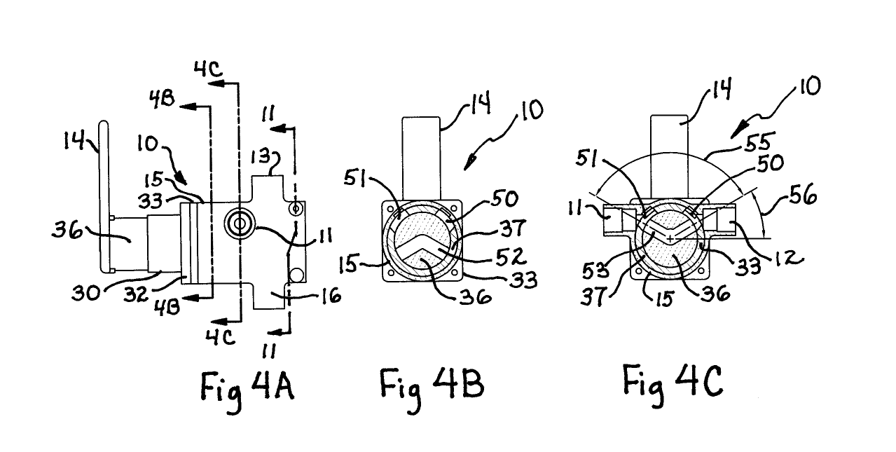

FIGS. 4A, 4B and 4C show the water flow paths of valve 10 when valve 10 is operated in the on configuration. FIG. 4A sets forth a side elevation view of valve 10 having handle 14 move to the on position (12:00) seen in FIG. 3A. FIG. 4B shows a section view of valve 10 in the on position taken along section lines 4B-4B in FIG. 4A. While FIG. 4C sets forth a section view of valve 10 in the on position taken along section lines 4C-4C in FIG. 4A.

With simultaneous reference to FIGS. 4A, 4B and 4C, valve 10 includes a housing 15 having a cold water input 11, a hot water input 12 together with outputs 13 and 16. Housing 15 further supports flanges 32 and 33. A generally cylindrical bypass sleeve 37 is received within housing 15 and secured therein by a pair of lock rings 60 and 61 (seen in FIG. 7). As is also better seen in FIG. 7, bypass sleeve 37 defines a pair of lateral channels 50 and 51. A valve stem 36 is received within sleeve 37 and is rotatable therein. Valve stem 36 is secured to handle 14 by a conventional fastener (seen in FIG. 7) and is secured to flange 32 by a lock nut 30. Valve stem 36 defines a V-shaped bypass passage 52 and a V-shaped primary flow passage 53. As is seen in FIGS. 4B and 4C, bypass passage 52 and primary flow passage 53 are offset within valve stem 37. Also seen in FIG. 4B, sleeve 37 is positioned within housing 15 such that lateral channels 50 and 51 are aligned with hot water input 12 and cold water input 11 respectively.

With specific reference to FIG. 4C, it will be noted that inputs 11 and 12 are aligned along a common horizontal axis. It will also be noted that in the preferred fabrication of the present invention, that passage 53 forms a V-shaped passage having an angle, angle 55, which is preferably 120 degrees. This angle has been found to be advantageous in the implementation of the present invention valve. Similarly, it has been found to be advantageous to utilize angle 56 at 30 degrees by selecting the positions of passage 53, lateral channels 50 and 51 as well as the alignment and positions of inputs 11 and 12. It will be further noted that passage 52 (seen in FIG. 4B) is substantially identical to passage 53 for the same reasons.

In the off position of handle 14, valve stem 36 is rotated to a position in which bypass passage 52 is moved out of alignment with lateral channels 50 and 51. Conversely, in the on configuration shown with handle 14 at the 12:00 position, primary flow passage 53 is aligned with lateral flow channels 50 and 51. As is better seen in FIG. 7, valve stem 36 further defines a rearwardly extending output passage 58 which extends from primary flow passage 53 rearwardly through valve stem 36. As is also better seen in FIG. 7, valve stem 36 defines a vertical discharge passage 57 extending through valve stem 36. Discharge passage 57 is aligned with outputs 13 and 16. Accordingly, with valve handle 14 in the on position (12:00) and with primary flow passage 53 aligned with cold water input 11 and hot water input 12, water flows inwardly through primary flow passage 15 and rearwardly through output passage 58 (seen in FIG. 7). Thereafter, water flows into discharge passage 57 (also seen in FIG. 7) and outwardly from valve 10 through output s 13 and 16. It will be noted that small angular movement of handle 14 and valve stem 36 alters the proportionate flow of cold water entering primary flow passage 53 through input 11 and hot water entering primary flow passage 53 entering through hot water input 12. As a result, the temperature of water discharged from valve 10 may be varied. Lateral channels 50 and 51 serve to couple the water flows from inputs 12 and 11 respectively to be combined within primary flow passage 53.

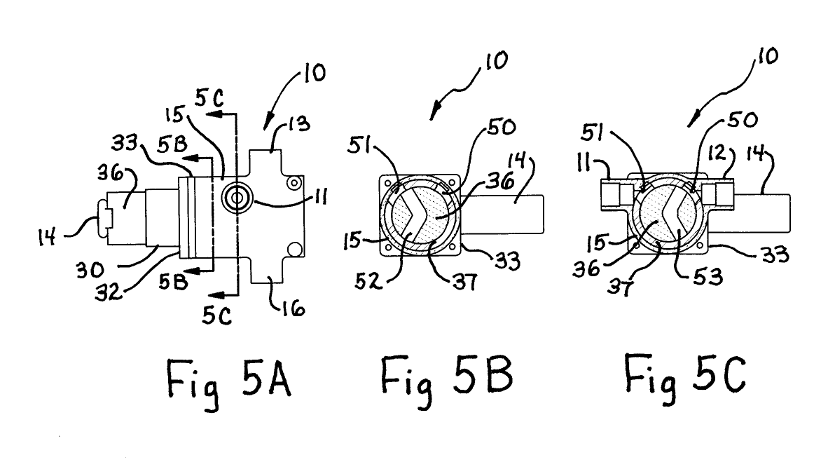

FIGS. 5A, 5B and 5C set forth the corresponding views of valve 10 shown in FIGS. 4A, 4B and 4C above with the difference being found in the rotation of handle 14 to the off position (9:00) of valve 10. Thus, as described above, valve 10 is shown in side elevation in FIG. 5A while FIG. 5B sets forth a section view of valve 10 taken along section lines 5B-5B in FIG. 5A. Similarly, FIG. 5C corresponds to FIG. 4C and sets forth a section view of valve 10 taken along section lines 5C-5C. Thus, with handle 14 of valve 10 in the off position, FIG. 5B shows valve stem 36 rotated to an angular position in which one end of bypass passage 52 is aligned with lateral channel 51 while the opposite end thereof is closed by a surface of valve sleeve 37. As a result, no water flow through bypass passage 52 is able to occur. Bypass passage 52 is in effect closed.

In FIG. 5C it will be noted that the rotation of handle 14 to the 9:00 position and the corresponding rotation of valve stem 36 to the position shown in FIG. 5C brings one end of primary flow passage 53 into alignment with lateral channel 50. However, it will also be noted that the remaining end of primary flow passage 53 is closed by the interior surface of valve sleeve 37. As a result, water is not able to flow through primary flow passage 53. Accordingly, with bypass passage 52 and primary flow passage 53 both closed by the position of valve stem 36 within valve sleeve 37, water flow through valve 10 is prevented. This corresponds to the off configuration of valve 10.

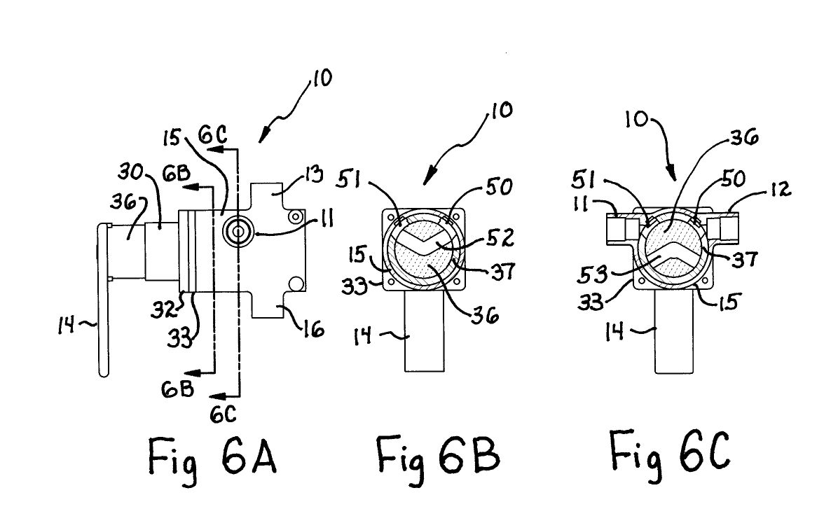

FIGS. 6A, 6B and 6C set forth views of valve 10 corresponding to FIGS. 4A, 4B and 4C above with the difference being found in the rotation of handle 14 to the bypass position (6:00). Thus, in correspondence to the above-described figures, FIG. 6B sets forth a section view of valve 10 taken along section lines 6B-6B in FIG. 6A while FIG. 6C sets forth a section view of valve 10 taken along section lines 6C-6C in FIG. 6A.

With specific attention to FIG. 6B, the positioning of handle 14 at the 6:00 position rotates valve stem 36 to the position shown. In this position, bypass passage 52 has one end aligned with lateral channel 50 and the opposite end aligned with lateral channel 51. As a result, a bypass flow through valve 10 in enabled which water is able to flow directly between inputs 11 and 12. With temporary return to FIG. 1, it will be recalled that valve 10 when moved to the bypass configuration shown in FIGS. 6A, 6B and 6C also activates pump 25. It will be further recalled that the activation of pump 25 produces a higher pressure at hot water input 12 above that existing at cold water input 11. Returning to FIG. 6B, this difference in pressure causes hot water to flow through channel 50 into bypass passage 52 and outwardly through lateral channel 51. Accordingly, a flow of water from hot water input 12 through lateral channel 50, bypass passage 52, lateral channel 51 and cold water input 11 results. Thus, in accordance with an important aspect of the present invention with handle 14 in the bypass position (6:00) water recirculates within the system directly through valve 10 without the need of additional bypass plumbing or alteration of the plumbing configuration within the host shower or similar facility. This bypass flow continues until the freshly heated water (seen in FIG. 1) from water heater 20 has replaced the cooled water between heater 20 and valve 10.

FIG. 6C sets forth a section view corresponding to FIG. 4C above taken along section lines 6C-6C in FIG. 6A. Once again, with handle 14 rotated to the bypass position (6:00), valve stem 36 is rotated to a position in which primary flow passage 53 is closed at both ends against the interior surface of valve sleeve 37. Accordingly, no water flow from either cold water input 11 or hot water input 12 into primary flow passage 53 occurs. Correspondingly, no water flows outwardly through output passage 58 and discharge passage 57 (seen in FIG. 7).

Thus, in accordance with an important aspect of the present invention, the user is able to select the water flow path within and through valve 10 by rotational positioning of handle 14. In the above-described typical use of the present invention valve, the user approaching the system in which valve 10 has remained in the off configuration for a time sufficient to allow cooling of the heated water within the coupling pipes thereof is able to initiate a bypass cycle by moving handle 14 to the bypass position (6:00) and thereby initiate a bypass water flow in which the cooled water is transferred to valve 10 and returned to the cold water input side of the water heater. This bypass flow draws freshly heated water into the supply pipe between the hot water heater and the present invention valve until a supply of heated water again fills the supply pipe of the valve. Once the input water to valve 10 has been replaced with freshly heated water, the user is then able to move handle 14 to the on position (12:00). With handle 14 moved to the on position, the bypass flow is terminated and the normal on flow from both hot water and cold water inputs into the shower facility is initiated. Small angular movements of handle 14 provide adjustment of the temperature of water supplied to the facility.

FIG. 7 sets forth a perspective assembly view of valve 10. As described above, valve 10 includes a housing 15 which receives a valve sleeve 37 which in turn receives a valve stem 36. As is also described above, valve 10 includes a handle 14 coupled to valve stem 36 which is rotated to adjust the rotational position of valve stem 36 within valve stem 37 to provide the water flow selection set forth above in FIGS. 4, 5 and 6.

More specifically, valve 10 includes a housing 15 having a flange 33 at the forward end thereof. Housing 15 further defines an interior bore 45 together with a pair of inputs 11 and 12 and a pair of outputs 13 and 16. A switch housing 34 is also formed on housing 15. Valve 10 further includes a valve sleeve 37 defining a generally cylindrical shape and having a cylindrical bore 59 extending therethrough. Valve sleeve 37 defines a plurality of grooves 80, 81 and 82 which receive a corresponding plurality of O-ring seals 90, 91 and 92 respectively. Valve sleeve 37 further defines a pair of angularly spaced lateral channels 50 and 51. Lateral channel 51 includes a pair of apertures 65 and 66 at each end thereof. Similarly, lateral channel 50 includes end apertures 67 and 68. Lateral channel 50 is identical to lateral channel 51 and both provide water flow channels between their respective end apertures. With O-rings 90, 91 and 92 installed within grooves 80, 81 and 92 respectively, valve sleeve 37 is assembled within bore 45 of housing 15.

Valve stem 36 defines a generally cylindrical body defining a V-shaped bypass passage 52 together with a V-shaped primary flow passage 53 extending therethrough. As mentioned above, valve stem 36 further defines an output passage 58 extending therethrough together with a discharge passage 57. Discharge passage 57 provides a flow path between primary flow passage 53 and discharge passage 57. Valve stem 36 further defines a plurality of grooves 74, 75, 76 and 77 which receive a corresponding plurality of O-ring seals 84, 85, 86 and 87 respectively. Additionally, valve stem 36 defines a lock ring groove 72 at one end and a lock ring groove 73 at the opposite end.

With O-rings 84 through 87 received within grooves 74 through 77 respectively, valve stem 36 is assembled within bore 59 of valve sleeve 37. Thereafter, a lock ring 61 is installed within lock ring groove 73 and a lock ring 60 is assembled within lock ring groove 72. As a result, the combination of valve sleeve 37 and valve stem 36 are assembled within housing 15 of valve 10. A plug 62 is installed within valve stem 36 and a magnet 63 is installed within the rear surface of valve stem 36. Once valve stem 36 has been secured within valve sleeve 37 and housing 15, flange 32 is secured to flange 33 using a plurality of conventional threaded fasteners (not shown). Finally, a decorative shower face plate 33 is positioned above end 71 of valve stem 37 after which a conventional lock nut 30 is threadably secured to flange 32 and face plate 38 upon end 71. As a final assembly step, handle 14 is secured to end 71 of valve stem 36 using a conventional fastener 31 which is received within a threaded aperture 70 formed in end 71 of valve stem 36.

FIGS. 8A, 8B, 8C and 8D set forth illustrative water flow diagrams showing the water flow through valve 10 for each position of handle 14. FIG. 8A shows the water flow diagram for valve 10 in the open or operate position with handle 14 at 12:00. FIG. 8B sets forth the flow diagram corresponding to valve 10 with handle 14 positioned at the closed position (3:00). FIG. 8C sets forth the water flow diagram for valve 10 resulting from positioning handle 14 at the bypass position (6:00). FIG. 8D sets forth a redundant off position of valve 10 which results from positioning handle 14 at the 3:00 position.

FIG. 8A showing the open or normal operate position of handle 14 at 12:00 results in a water flow pattern in which cold water flows inwardly at input 11 into lateral channel 51. The water flow from lateral channel 51 then enters and flows through primary flow channel 53. Simultaneously, hot water flows inwardly at input 12 to lateral channel 50. The inward flow enters primary flow channel 53. The flow of water into primary flow channel 53 then flows outwardly through output passage 58 to discharge passage 57. Water flowing outwardly from discharge passage 57 continues outwardly through outputs 13 and 16 of valve 10 (seen in FIG. 1). It will be noted that with handle 14 in the open position, bypass flow channel 52 is out of communication with lateral channels 50 and 51. Accordingly, no water flow through bypass channel 52 is provided.

FIG. 8B sets forth the water flow diagram for valve 10 resulting when handle 14 is moved to the off position (9:00). With simultaneous reference to FIG. 8D, a redundant closed configuration is provided when handle 14 is moved to the alternative off position (3:00). Thus, with simultaneous reference to FIGS. 8B and 8D, the off position flow diagram is shown. Water flows inwardly at input 11 to lateral channel 51 and inwardly at input 12 to lateral channel 50. However, because the rotational position of valve 10 moves primary flow passage 53 and bypass passage 52 away from communication with both lateral passages 50 and 51, no water flow occurs through valve 10.

FIG. 8C sets forth the water flow diagram for valve 10 resulting from positioning handle 14 in the bypass position (6:00). With valve 10 in the bypass configuration, hot water input 12 flows water into lateral channel 50. In the bypass position, bypass flow passage 52 has one end aligned with lateral flow passage 50. Additionally, bypass flow passage 52 has its remaining end aligned with lateral flow passage 51 which in turn is in communication with input 11. Because of the above-mentioned pressure provided by pump 25 (seen in FIG. 1) at input 12, water flows inwardly through lateral channel 50, through bypass flow passage 52, lateral passage 51 and outwardly through cold water input 11. Because primary flow channel 53 is out of alignment with lateral channels 50 and 51, no water flow outwardly through output passage 58 and discharge passage 57 occurs. As a result, water flows through valve 10 passing into valve 10 through hot water input 12 and passing outwardly from valve 10 through cold water input 11 to provide the above-described circulation of cooled water away from and returning to heater 20 (seen in FIG. 1).

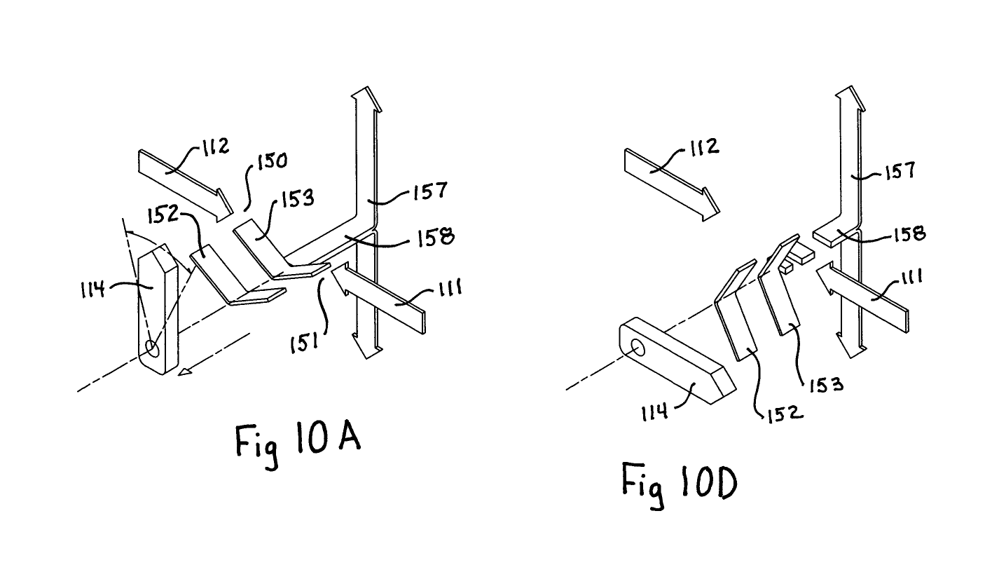

FIG. 9 sets forth a perspective assembly view of an alternate embodiment or the present invention valve generally referenced by numeral 110. Valve 110 includes a housing 115 which receives a valve sleeve 137 which in turn receives a valve stem 136. Valve 110 includes a handle 114 coupled to valve stem 136 which is rotated to adjust the rotational position of valve stem 136 and which is pulled or pushed within valve stem 137 to provide the water flow selection similar to that set forth above in FIGS. 4, 5 and 6.

More specifically, valve 110 includes a housing 115 having a flange 133 at the forward end thereof. Housing 115 further defines an interior bore 145 together with a pair of inputs 111 and 112 and a pair of outputs 113 and 116. A switch housing 134 is also formed on housing 115. Valve 110 further includes a valve sleeve 137 defining a generally cylindrical shape and having a cylindrical bore 159 extending therethrough. Valve sleeve 137 defines apertures 150, 151 and 169. Valve stem 137 further defines a plurality of grooves 180, 181 and 182 which receive a corresponding plurality of O-ring seals 190, 191 and 192 respectively. With O-rings 190, 191 and 192 installed within grooves 180, 181 and 182 respectively, valve sleeve 137 is assembled within bore 145 of housing 115.

Valve stem 136 defines a generally cylindrical body defining a V-shaped bypass passage 152 together with a V-shaped primary flow passage 153 extending therethrough. Valve stem 136 further defines an output passage 158 extending therethrough together with a discharge passage 157. Discharge passage 157 provides a flow path between primary flow passage 153 and discharge passage 157. Valve stem 136 further defines a plurality of grooves 174, 175, 176 and 177 which receive a corresponding plurality of O-ring seals 184, 185, 186 and 187 respectively.

With O-rings 184 through 187 received within grooves 174 through 177 respectively, valve stem 136 is assembled within bore 159 of valve sleeve 137. As a result, the combination of valve sleeve 137 and valve stem 136 are assembled within housing 115 of valve 110. Once valve stem 136 has been secured within valve sleeve 137 and housing 115, flange 132 is secured to flange 133 using a plurality of conventional threaded fasteners (not shown). Finally, a decorative shower face plate 133 is positioned above end 171 of valve stem 137 after which a conventional lock nut 130 is threadably secured to flange 132 and face plate 138 upon end 171. As a final assembly step, handle 114 is secured to end 171 of valve stem 136 using a conventional fastener 131 which is received within a threaded aperture 170 formed in end 171 of valve stem 136.

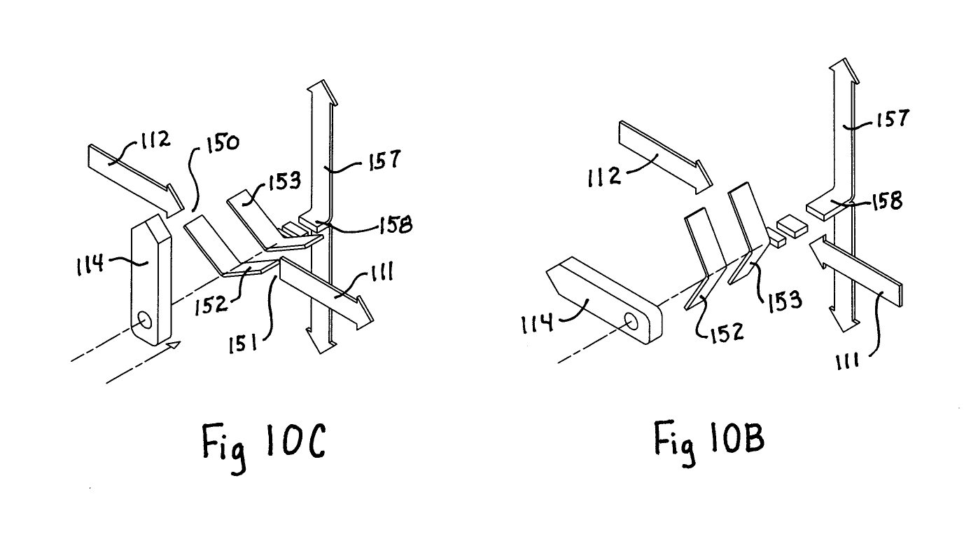

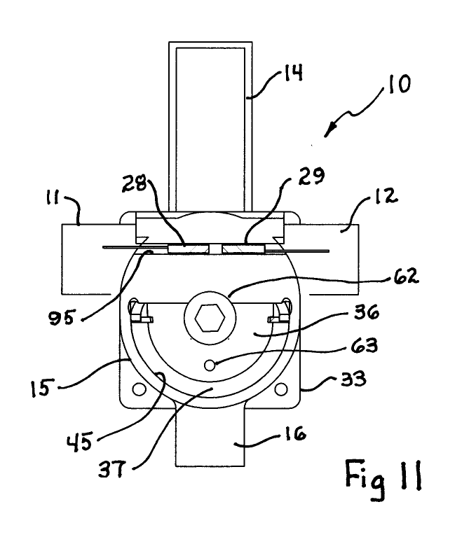

FIGS. 10A, 10B, 10C and 10D set forth illustrative water flow diagrams showing the water flow through valve 110 for each position of handle 114 and for each push-pull position of valve stem136. FIG. 10A shows the water flow diagram for valve 110 when valve stem 136 is pulled outwardly and in the open or operate position with handle 114 at 12:00. FIG. 10B sets forth the flow diagram corresponding to valve 110 with handle when handle 114 is pulled and 114 is positioned at the closed position (3:00). FIG. 10C sets forth the water flow diagram for valve 110 resulting from pushing handle 114 inward and positioning handle 114 at the bypass position (6:00). FIG. 10D sets forth a redundant off position of valve 110 which results from pulling handle 114 and positioning handle 114 at the 3:00 position.

FIG. 10A showing the open or normal operate position of handle 114 pulled and rotated to 12:00 which results in a water flow pattern in which cold water flows inwardly at input 111 into primary flow channel 153. Simultaneously, hot water flows inwardly at input 112 to primary flow channel 153. The flow of water into primary flow channel 153 then flows outwardly through output passage 158 to discharge passage 157. Water flowing outwardly from discharge passage 57 continues outwardly through outputs 13 and 16 of valve 10 (seen in FIG. 1). It will be noted that with handle 114 in the open position, bypass flow channel 152 is out of communication with lateral channels 111 and 112. Accordingly, no water flow through bypass channel 152 is provided.

FIG. 10B sets forth the water flow diagram for valve 110 resulting when handle 114 is pulled outwardly and moved to the off position (9:00). With simultaneous reference to FIG. 8D, a redundant closed configuration is provided when handle 14 is moved to the alternative off position (3:00). Thus, with simultaneous reference to FIGS. 10B and 10D, the off position flow diagram is shown. The rotational position of valve stem 136 moves primary flow passage 153 and bypass passage 152 away from communication with both inputs 111 and 112 and therefore no water flow occurs through valve 110.

FIG. 10C sets forth the water flow diagram for valve 110 resulting from pushing handle 114 inwardly and positioning handle 14 in the bypass position (6:00). With valve 110 in the bypass configuration, hot water input 112 flows water into bypass flow passage 152 which in turn is in communication with input 111. Because of the above-mentioned pressure provided by pump 25 (seen in FIG. 1) at input 112, water flows inwardly through bypass flow passage 152, and outwardly through cold water input 111. Because primary flow channel 153 is out of alignment with inputs 111 and 112, water flows through valve 110 passing into valve 110 through hot water input 112 and outwardly from valve 110 through cold water input 111 to provide the above-described circulation of cooled water away from and returning to heater 20 (seen in FIG. 1).

FIG. 11 sets forth a section view the present invention hot water recirculation valve 10 taken along section lines 11-11 in FIG. 4A. As described above, valve 10 includes a housing 15 having a flange 33, a pair of water inputs 11 and 12, and a water output 16. Housing 15 further defines a bore 45 which receives a bypass sleeve 37. Within bypass sleeve 37 a valve stem 36 is rotatably supported. A handle 14 is joined to valve stem 36 and is used to rotate valve stem 36 between the on position shown and an off position at 9 'clock and a bypass position at 6 o'clock. Housing 15 also defines a bore 95. A thermocouple switch 28 and a magnetic switch 29 are received within bore 95. A magnet 63 is supported by valve stem 36. As is described above, thermocouple switch 28 and magnetic switch 29 are series connected such that pump 25 (seen in FIG. 1) is activated only when both switches are in a closed configuration. As is also described above Thermocouple switch 28 is closed when cool water is sensed at valve 10. Magnetic switch 29 remains open unless and until handle 14 rotates valve stem 36 to the 6 o'clock bypass position. When valve stem 36 is in the 6 o'clock bypass position magnet 63 is moved into close proximity to magnetic switch 29 which in turn closes switch 29. As a result, The pump circulates ware in response to the temperature sensed by thermocouple switch 28.

What has been shown is an improved hot water recirculating system that may be retro-fitted to existing shower facilities. The system shown provides an improved hot water recirculation system that is particularly suited for original installation at the time of construction or conversion of an existing shower facility to include hot water recirculation. The system shown makes possible a hot water recirculation system that does not necessitate a constant hot water recirculation.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

That which is claimed is:

1. A valve for use in a water circulation system having a source of unheated water and a source of heated water, said valve comprising:
a housing defining a heated water input, an unheated water input and an output;
a valve stem supported within said housing defining a primary flow passage, an output passage in fluid communication with said primary flow passage and a bypass flow passage;
a handle constructed to facilitate movement of said valve stem between an off position, an on position and a bypass position,
wherein said on position has said valve stem positioned within said housing such that said primary flow passage provides water flow from said heated water input and said unheated water input to said output passage and said bypass passage is blocked and wherein said off position has said primary flow passage and said bypass passage blocked and wherein said bypass position has said bypass flow passage couples said heated water input to said unheated water input and said primary flow passage is blocked.
